(19) United States
(12) Patent Application Publication
(10) Pub. No.: US 2025/0136039 A1
(43) Pub. Date: May 1, 2025

(54) SEATBELT RETRACTOR

(71) Applicant: ZF Passive Safety Systems US Inc., Washington, MI (US)

(72) Inventors: Chhay Siev, Macomb, MI (US); Wade Sorensen, Oxford, MI (US)

(21) Appl. No.: 18/495,813

(22) Filed: Oct. 27, 2023

(51) Int. Cl. B60R 22/34; B60R 22/40

(52) U.S. Cl. CPC B60R 22/341; B60R 22/40

(57) ABSTRACT

A seatbelt retractor for a vehicle seatbelt webbing includes a frame and a spool rotatably mounted to the frame. The spool is configured to have the seatbelt webbing wound thereon. First and second bands are disposed in the spool symmetrically about an axis of the spool. The first and second bands are configured to plastically deform to at least partially absorb a load on the seatbelt webbing.

### TECHNICAL FIELD

The present invention relates to a seatbelt retractor for a vehicle seatbelt webbing.

### BACKGROUND OF THE INVENTION

U.S. Pat. No. 6,926,221 (“the '221 patent”) discloses a known belt retractor for a vehicle seatbelt webbing. This belt retractor includes a frame, a spool rotatably mounted on the frame, and first and second energy absorbing coils. The first energy absorbing coil includes three strips that are disposed symmetrically with respect to a rotational axis of the spool. The second energy absorbing coil similarly includes three strips that are disposed symmetrically with respect to the rotational axis of the spool. Unlike the first energy absorbing coil, the second energy absorbing coil can be selectively deactivated during use. Therefore, both energy absorbing coils may initially be connected in parallel during a first phase in which a particularly high energy absorbing load is achieved. After the first phase, the second energy absorbing coil can be deactivated via a pyrotechnical actuator to achieve a lower energy absorbing load.

The belt retractor of the '221 patent thus requires pyrotechnics and many strips to achieve the desired load levels. As such, the belt retractor of the '221 patent is a relatively expensive and complex belt retractor.

### SUMMARY OF THE INVENTION

According to an aspect of the invention, alone or in combination with any other aspect, a seatbelt retractor for a vehicle seatbelt webbing comprises a frame and a spool rotatably mounted to the frame. The spool is configured to have the seatbelt webbing wound thereon. First and second bands are disposed in the spool symmetrically about an axis of the spool. The first and second bands are configured to plastically deform to at least partially absorb a load on the seatbelt webbing.

According to an aspect of the invention, alone or in combination with any other aspect, the seatbelt retractor for a vehicle seatbelt webbing comprises a locking disk that is rotatable relative to the frame. The locking disk is prevented from rotating relative to the frame in an emergency state of a vehicle. A torsion bar has a first end rotationally fixed to the spool and a second end rotationally fixed to the locking disk. Plastic deformation of the torsion bar permits the spool to rotate about an axis relative to the locking disk in the emergency state. First end portions of the first and second bands are connected to the locking disk. Second end portions of the first and second bands are connected to the spool such that rotation of the spool relative to the locking disk plastically deforms the first and second bands.

According to an aspect of the invention, alone or in combination with any other aspect, the seatbelt retractor has a high energy absorption (“EA”) load level in which the torsion bar and the first and second bands deform plastically to absorb energy in the seat belt webbing, and a low EA load level in which the torsion bar alone deforms plastically to absorb the energy in the seatbelt webbing.

According to an aspect of the invention, alone or in combination with any other aspect, the second end portions of the first and second bands simultaneously disengage from the spool after the spool rotates a predetermined degree relative to the locking disk. This disengagement switches the seatbelt retractor from the high EA load level to the low EA load level without the use of pyrotechnics.

According to an aspect of the invention, alone or in combination with any other aspect, the seatbelt retractor has a first energy absorption state in which each and every band of the seatbelt retractor is operatively connected to the spool so that rotation of the spool relative to the locking disk plastically deforms all of the bands, and a second energy absorption state in which each and every band of the seatbelt retractor is operatively disconnected from the spool so that none of the bands plastically deform as the spool rotates relative to the locking disk.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a perspective side view of a seatbelt retractor according to an example embodiment of the present disclosure;

FIG. 2 is a cross-sectional view taken along line 2-2 of FIG. 1;

FIG. 3 is a rear exploded view of a portion of the seatbelt retractor of FIG. 1;

FIG. 4 is a front exploded view of the portion shown in FIG. 3;

FIG. 5 is a rear view of a portion of the seatbelt retractor of FIG. 1;

FIG. 6 is a front cross-sectional view of a portion of the seatbelt retractor of FIG. 1;

FIG. 7 is a perspective side view of a portion of the seatbelt retractor of FIG. 1;

FIG. 8 is graph showing a characteristic of the energy absorption load of the seatbelt retractor of FIG. 1;

FIG. 9 is a rear exploded view of an alternate configuration of a portion of the seatbelt retractor of FIG. 1;

FIG. 10 is a rear cross-sectional view a portion of the seatbelt retractor of FIG. 9; and

FIG. 11 is a front cross-sectional view of a portion of the seatbelt retractor of FIG. 9.

### DETAILED DESCRIPTION

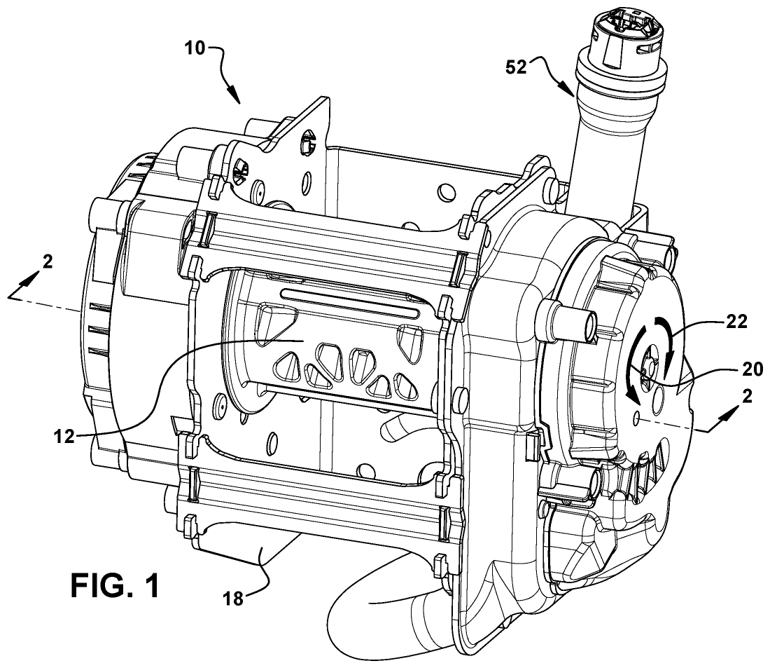

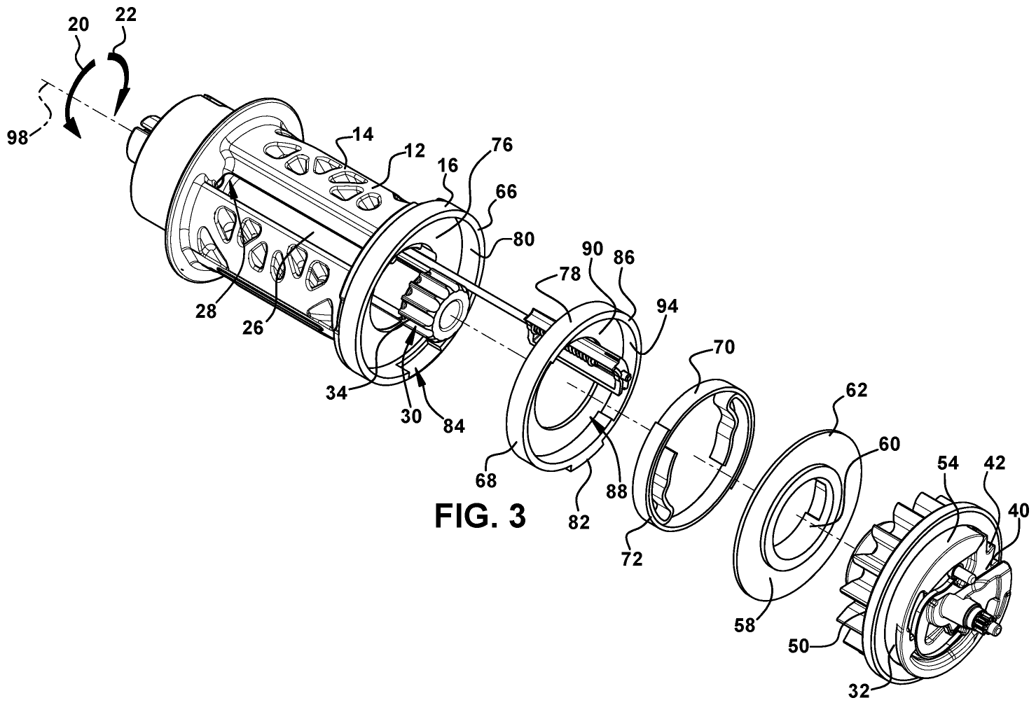

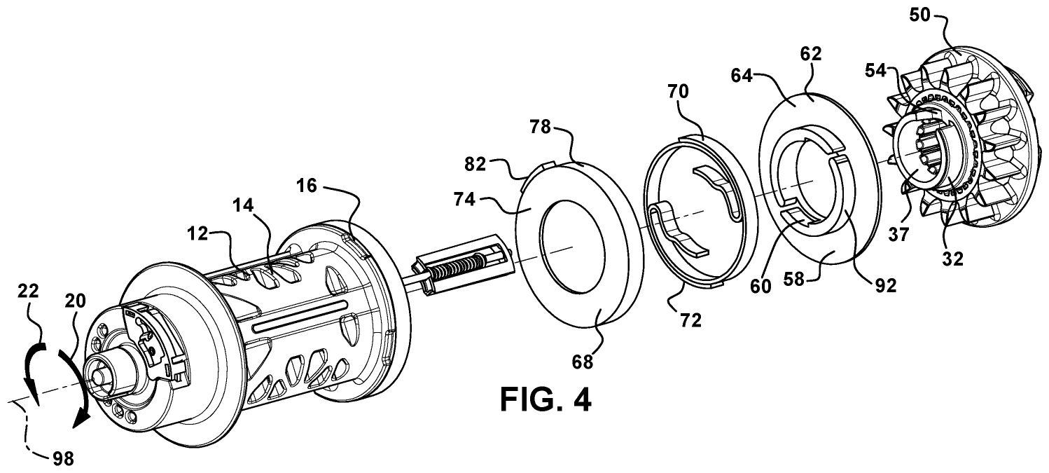

FIGS. 1-6 illustrate an example seatbelt retractor 10 design in accordance with the present disclosure. The seatbelt retractor 10 includes a spool 12 having a first cylinder portion 14 and a second cylinder portion 16 formed in one-piece with the first cylinder portion. The second cylinder portion 16 has larger outer and inner diameters than that of the first cylinder portion 14.

The spool 12 is rotatably mounted to a frame 18 so that a length of seatbelt webbing (not shown for reasons of clarity) to be wound on and unwound from the spool (e.g., wound and unwound on the first cylinder portion 14). More particularly, the spool 12 is rotatable in a webbing withdrawal direction 20 and an opposite webbing retraction direction 22. A spring 24 acts on the spool 12 to bias the spool in the webbing retraction direction 22.

A torsion bar 26 extends in an axial direction through an interior of the spool 12. A first end 28 of the torsion bar 22 is rotationally fixed to the spool 12 (e.g., via one or more spline-in-grove engagements) such that the first end rotates with (i.e., not relative to) the spool. A second end 30 of the torsion bar 26 is rotationally fixed to a locking disk 32 such that the second end rotates with the locking disk. For example, the second end 30 of the torsion bar 26 may be rotationally fixed to the locking disk 32 via splines 34 that are received in grooves 36 on or adjacent to an inner periphery 37 of the locking disk.

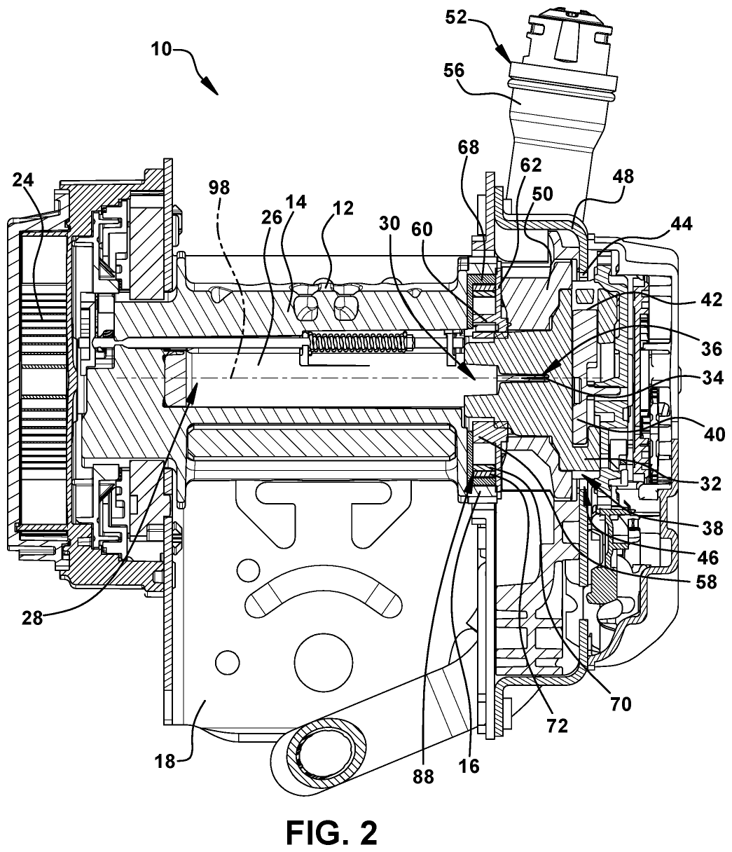

The locking disk 32 is but one part of a locking mechanism 38 that is configured to block a rotational movement of the spool 12 relative to the frame 18 in the webbing withdrawal direction 20 under certain conditions. The locking mechanism 38 also includes a pawl 40 that has one end pivotably mounted to the locking disk 32. The other end of the pawl 40 includes a plurality of teeth 42. By means of a conventional locking mechanism (such as the one shown and described in U.S. Pat. No. 10,315,617 to Franz et al. (“the '617 patent”), the subject matter of which is incorporated by reference in its entirety), the pawl 40 can be pivoted from a rest position (shown in FIG. 2) into engagement with teeth 44 that are formed about an opening 46 in a supplemental portion 48 of the frame 18. Rotational movement of the locking disk 32 relative to the frame 18 in the webbing withdrawal direction 20 is blocked after (e.g., immediately or almost immediately after) the pawl teeth 42 engage the frame teeth 44.

Further, as a result of the inter-engagement between the grooves 36 in the locking disk 32 and the splines 34 on the torsion bar 26, rotation of the second end 30 of the torsion bar in the webbing withdrawal direction 20 is also blocked. The spool 12, being rotationally fixed to the first end 28 of the torsion bar 26, is at least partially restricted from rotating in the webbing withdrawal direction 20 when the torsion bar 26 is blocked from rotating in the webbing withdrawal direction. The torsion bar 26 thus operatively connects the spool 12 to the locking mechanism 38.

A turbine wheel 50 of a pretensioner 52 is rotationally fixed to the locking disk 32 so that the turbine wheel and the locking disk rotate with one another. As shown, the turbine wheel 50 is formed separately from the locking disk 32 and subsequently attached to an outer periphery 54 of the locking disk in a rotationally fixed manner. As an alternative, the turbine wheel 50 and the locking disk 32 may have a one-piece construction so as to be rotationally fixed to one another. Although not shown in detail, the pretensioner 52 includes a tube 56 that houses a gas generator and one or more features that rotate the turbine wheel 50 in the webbing retraction direction 22 in response to actuation of the gas generator. An example of such a pretensioner is shown and described in the '617 patent. Rotation of the turbine wheel 50 is transmitted to the spool 12 via the locking disk 32 and the torsion bar 26 and thereby causes the spool to rotate in the webbing retraction direction 22 to wind up the seatbelt webbing on the spool. The winding rotation of the spool 12 effectively reduces or eliminates slack in the seatbelt webbing wound on the spool and also pulls the seatbelt webbing closely and tightly against a vehicle occupant (not shown).

A fixing disk 58 is also rotationally fixed to the locking disk 32 so that the fixing disk and the locking disk rotate with one another. As shown, the fixing disk 58 is formed separately from the locking disk 32 and subsequently attached to the outer periphery 54 of the locking disk in a rotationally fixed manner. As an alternative, the fixing disk 58 and the locking disk 32 may have a one-piece construction so as to be rotationally fixed to one another. The fixing disk 58 is a one-piece construction having a hub 60, via which the fixing disk is joined to the locking disk 32, and an annular flange 62 extending radially from the hub. At least a portion of the hub 60 extends into the second cylinder portion 16, while the flange 62 remains external to the second cylinder portion.

A spool-side axial surface 64 of the flange 62 is adjacent to and/or abuts an outer axial surface 66 of the second cylinder portion 16. This particular positioning helps retain an insert 68 and first and second bands 70, 72 in the second cylinder potion 16 during use. It should be noted that any contact between the axial surface 64 of the flange 62 and the outer axial surface 66 does not (or does not significantly) restrict the rotation of the spool 12, the rotation of the fixing disk 58, or any relative rotation between the spool and the fixing disk.

The insert 68 is substantially ring-shaped and has a first axial surface 74 adjacent to and/or contacting an inner axial surface 76 of the second cylinder portion 16. Furthermore, an outer periphery 78 of the insert 68 is adjacent to and/or contacting an inner periphery 80 of the second cylinder portion 16 that extends axially between the outer and inner axial surfaces 66, 76. The insert 68 may be rotationally fixed to the spool 12 so that the insert and the spool rotate with one another. For example, the insert 68 may include a radially extending projection 82 that is received in a recess 84 of the inner periphery 80 of the second cylinder portion 16.

A second axial surface 86 of the insert 68 is adjacent to and/or abuts the axial surface 64 of the flange 62 such that a cavity 88 is defined between the insert and the fixing disk 58. More specifically, the cavity 88 is annular and defined by an inner axial surface 90 of the insert 68, the axial surface 64 of the flange 62, an outer periphery 92 of the hub 60 and an inner periphery 94 of the insert. It should be noted that any contact between the axial surface 64 of the flange 62 and the second axial surface 86 of the insert 68 does not (or does not significantly) restrict the rotation of the spool 12, the rotation of the fixing disk 58, or any relative rotation between the spool and the fixing disk. Furthermore, the flange 62 may be configured such that the flange at least partially is positioned in the second cylinder portion 16. In such configuration, the flange 62 may be radially adjacent to and/or radially abut the inner periphery 80 of the second cylinder portion 16.

At least a portion of the first and second bands 70, 72 extend substantially circumferentially inside the cavity 88. The first band 70 has a first end portion 96 (i.e., an end closest to an axis 98 on which the spool 12 and the locking disk 32 are coaxially arranged) fixed to the hub 60 in the second cylinder portion 16. In particular, the first end portion 96 includes a first end face 100 that circumferentially abuts (i.e., directly contacts) a complementary inner shoulder 102 of the hub 60. The inner shoulder 102 is formed by a radial drop-off on an inner periphery 104 of the hub 60. The first end portion 96 extends from the inner shoulder 102 through a substantially radially extending slot 106 in the hub 60 toward the outer periphery 92 of the hub. The first end portion 96 and the slot 106 may be configured so that a press-fit and/or frictional engagement is created between the first end portion and the slot. The press-fit and/or frictional engagement between the first end portion 96 and the slot 106 rotationally fixes the first end portion to the fixing disk 58 and, thus, to the locking disk 32.

A middle portion 108 of the first band 70 extends from the first end portion 96 circumferentially around the outer periphery 92 of the hub 60 in the webbing withdrawal direction 20 to form an internal segment S1. Then, the middle portion 108 makes a U-turn to form a U-turn segment S2 in the cavity 88. After making the U-turn, the middle portion 108 extends in the webbing retraction direction 22 to form an external segment S3.

A second end portion 110 of the first band 70 (i.e., the end opposite the first end portion 96 and furthest from the axis 98) extends from the middle portion 108. The second end portion 110 engages the inner periphery 94 of the insert 68. In particular, the second end portion 110 includes a second end face 112 that circumferentially abuts a complementary inner shoulder 114 of the insert 68. The inner shoulder 114 is formed by a radial drop-off on the inner periphery 94 of the insert 68.

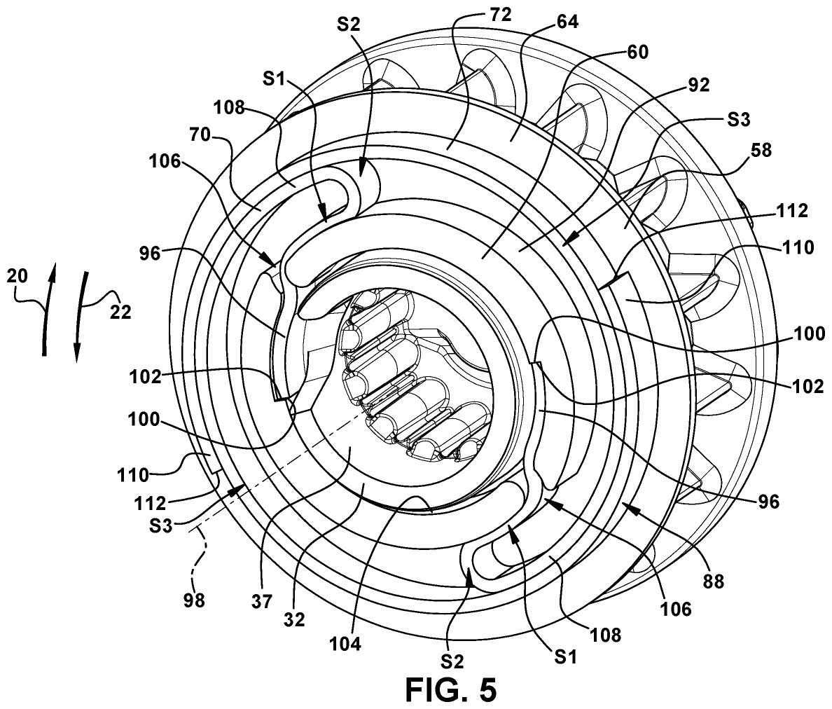

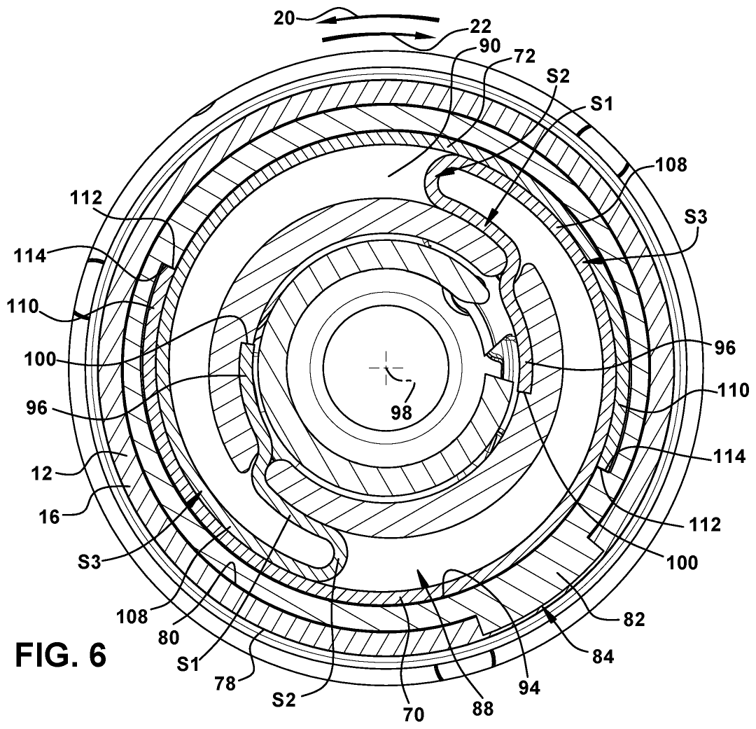

The second band 72 is structurally identical (or at least substantially structurally identical) to the first band 70 and, thus, is arranged in the retractor 10 in the same or similar manner as the first band. Accordingly, the above description of the first band 70 applies to the second band 72. The bands 70, 72, however, are disposed symmetrically with respect to the axis 98. In this way, a symmetrical load distribution is obtained, which leads to a particularly low load on the spool 12 via the fixing disk 58, the locking disk 32 and the torsion bar 26. As shown in FIGS. 5-6, the lengths of the bands 70, 72 (which is measured from the first end faces 100 to the second end faces 112) may be such that bands overlap one another. Such overlap does not inhibit the functionality of either band 70, 72.

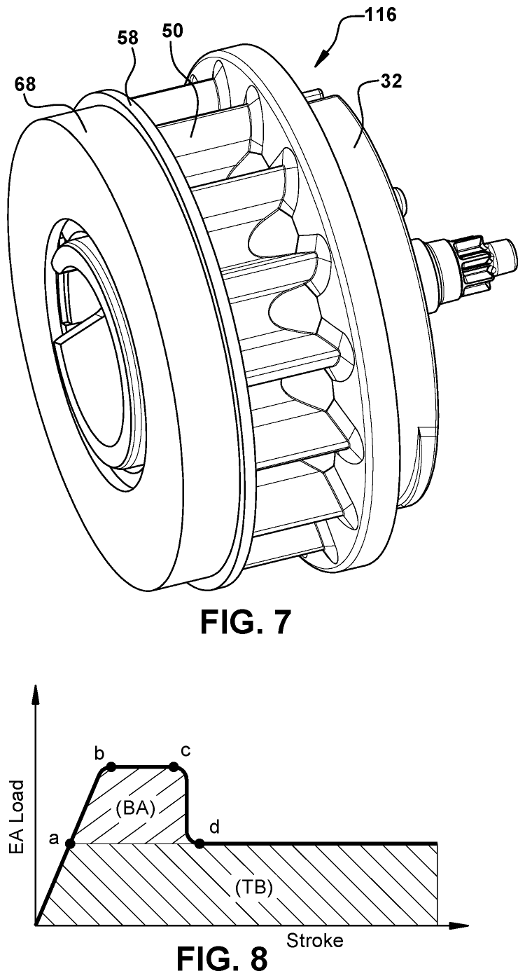

As shown in FIG. 7, because the turbine wheel 50 and the fixing disk 58 are fixed to the locking disk 32 and the insert 58 forms the cavity 88 with the fixing disk for housing the bands 70, 72, these features can be pre-assembled as a single unit 116 prior to joining them to the remainder of a corresponding retractor 10. More specifically, the locking disk 32, turbine wheel 50, fixing disk 58, insert 68 and the first and second bands 70, 72 may come or be packaged as a pre-assembled single unit 116. This single unit 116 can then be selected and joined to a corresponding spool 12 and torsion bar 26 during assembly of the retractor 10.

In use, when the retractor 10 is installed in a vehicle (not shown), the occupant grasps a buckle tongue (not shown) that is attached to the seatbelt webbing wound on the spool 12 and pulls the buckle tongue and the seatbelt webbing away from the retractor in order to don the seatbelt by drawing the seatbelt webbing across the occupant's body and connecting the buckle tongue to a buckle (not shown). As the seatbelt webbing is pulled away from the retractor 10, the webbing unwinds from the spool 12 and rotates the spool in the webbing withdrawal direction 20 against the bias of the spring 24. Because the spool 12 is connected to the torsion bar 26, and the torsion bar is connected to the locking disk 32, rotation of the spool effects rotation of the locking disk in the webbing withdrawal direction 20.

After the seatbelt has been donned by the occupant, subsequent low acceleration, low speed withdrawal and retraction movements of the seatbelt webbing in a normal state of the vehicle, as, for example, when the occupant adjusts his or her position in a vehicle seat (not shown), will produce low acceleration rotational movements of the spool 12 and consequent joint rotational movements of the locking disk 32.

In an emergency state of the vehicle (e.g., during a high-speed collision), the pretensioner 52 and the locking mechanism 38 may be actuated. The pretensioner 52 may be actuated in response to a vehicle sensor (not shown), such as an accelerometer mounted in the vehicle, detecting a rapid deceleration of the vehicle indicating the occurrence of the emergency state. The pretensioner 52 may alternatively or additionally be actuated in response to a vehicle sensor (not shown), such as a forward-looking radar unit or a forward-looking camera, detecting an anticipated and potentially unavoidable emergency state. The pretensioner 52 may alternatively or additionally be actuated in response to a vehicle sensor (not shown), such as a camera or a capacitive sensor directed toward or located adjacent to the occupant, detecting movement of the occupant indicating the occurrence of the emergency state. Any desired system or mechanism may be used to determine whether and when to actuate the pretensioner 52.

Actuation of the pretensioner 52 starts with actuation of the micro gas generator. When actuated, the micro gas generator produces or generates gas, which pushes one or more features against the turbine wheel 50, thereby rotating the turbine wheel in the webbing retraction direction 22. Rotation of the turbine wheel 50 is transmitted to the spool 12 via the locking disk 32 and the torsion bar 26 and, thus, causes the spool to rotate in the webbing retraction direction 22 to wind up the seatbelt webbing on the spool. Such winding rotation of the spool 12 effectively reduces or eliminates slack in the seatbelt webbing wound on the spool and also pulls the seatbelt webbing tightly against the occupant.

The occupant, however, in the emergency state, may move against the seatbelt webbing, which extends across the occupant's body. Such occupant movement, after operation of the pretensioner 52 is completed, will impose a load on the seatbelt webbing and urge the spool 12 to accelerate in the webbing withdrawal direction 20. The locking mechanism 38 may be configured such that, under such spool acceleration, the pawl 40 is pivoted from the rest position to a position in which the pawl's teeth 42 engage the frame's teeth 44 to prevent further rotation of the locking disk 32 and the second end 30 of the torsion bar 26 in the webbing withdrawal direction 20. Therefore, the locking disk 32 is rotationally locked to the frame 18 (e.g., to the supplemental portion 48 of the frame) via the pawl 40 when the pawl's teeth 42 engage the frame's teeth 44.

However, because the vehicle is in an emergency state the load in the seatbelt webbing is likely to be sufficient to cause rotation of the spool 12 in the webbing withdrawal direction 20 via rotation of the first end 28 of the torsion bar 26 relative to the second end 30 end consequent twisting and plastic deformation of the torsion bar. The plastic deformation of the torsion bar 26 absorbs at least a portion of the load in the seatbelt webbing and/or at least a portion of an impact energy of the seatbelt webbing on the moving occupant.

With this relative movement, the bands 70, 72 provided between the fixing disk 58, which is in a rotationally locked state via its connection to the locking disk 32, and the spool 12, which is rotating relative to the fixing and locking disks via the plastic deformation of the torsion bar 26, deform plastically and are wound around the outer periphery 92 of the hub 60 in the webbing withdrawal direction 20. In particular, the second end faces 112 of the bands 70, 72 are urged and/or pushed by the inner shoulders 114 of the insert 68 (which is rotationally fixed to the rotating spool 12) in the webbing withdrawal direction 20, which urges the bands to plastically deform and wind around the hub 60. Because the bands 70, 72 have the same or a substantially similar structure and are arranged in the retractor 10 in the same or a substantially similar manner, the bands are deformed together and at the same time, though the retractor 10 may be configured such that one band deforms ahead of the other. This plastic deformation of the bands 70, 72 further absorbs the seatbelt webbing load and/or the impact energy.

As the bands 70, 72 are wound around the outer periphery 92 of the hub 60, the lengths of their internal segments S1 increase and their U-turn segments S2 are displaced in the webbing withdrawal direction 20. Such deformation also shortens the external segments S3. The winding of the bands 70, 72 and the changes to the segments S1, S2, S3 continues in this manner until the second ends 112 are displaced to or beyond their corresponding U-turn segments S3. The seconds ends 112 simultaneously reaching or moving at least partially past the U-turn segments S3 causes the bands 70, 72 to unfurl at their U-turn segments, thereby eliminating the U-turn and external segments S2, S3. The second ends 112 are disengaged from the inner shoulders 114 and become free ends as the bands 70, 72 unfurl. Because the bands 70, 72 have the same or a substantially similar structure and are arranged in the retractor 10 in the same or a substantially similar manner, the bands disengage from the inner shoulders 114 at the same time, though the retractor 10 may be configured such that one band disengages ahead of the other.

When the spool 12 rotates relative to the second end 30 of the torsion bar 26 in the webbing withdrawal direction 20 and twists the torsion bar, plastic deformation of the torsion bar and the bands 70, 72 functions to absorb energy/seatbelt webbing load. The entire energy absorption (“EA”) load is a sum of the EA load when the torsion bar 26 twists and deforms and the EA load when the bands 70, 72 deform and are wrapped around the hub 60. Via the entire EA load, the impact energy applied to the moving occupant via the seatbelt webbing is absorbed and eased, and the load applied to the seatbelt webbing is restricted.

FIG. 8 is a graph showing a variation of the EA load generated via the torsion bar 26 and the bands 70, 72 when the impact energy is absorbed as described above. The horizontal axis shows a rotational stroke (angle) of the spool 12 relative to the locking disk 32 (and, thus, also relative to the second end 30 of the torsion bar 26 and the fixing disk 58).

As shown in FIG. 8, the EA load is zero when the rotational stroke of the spool 12 relative to the locking disk 32 is zero. Then, when the relative rotation described above starts and the stroke starts to increase, the EA load by the twist/deformation of the torsion bar 26 first increases proportionally. When the stroke increases up to a value (point a in FIG. 8), the plastic deformation of the bands 70, 72 starts in addition to the twist of the torsion bar 26. The entire EA load is the sum of the EA load by the torsion bar 26 (shown as TB in FIG. 8) and the EA load by the bands (shown as BA in FIG. 8). When the stroke increases further, the sum of the EA loads of the entire retractor 10 stops increasing at a fixed value (point b in FIG. 8). After that, despite increase of the stroke, the EA load is maintained at the fixed value (point b to point c in FIG. 8).

When the stroke increases further and the second ends 112 of the bands 70, 72 are disengaged from the inner shoulders 114, the EA load of the entire retractor 10 drops sharply (point c to point d in FIG. 8) because the EA load is no longer generated by the bands and is, instead, generated by the torsion bar 26 alone (TB). In other words, after the second ends 112 of the bands 70, 72 are simultaneously disengaged from the inner shoulders 114, the bands no longer absorb energy. After this disengagement, the EA load maintains the dropped value despite increase of the stroke (right side from point d in FIG. 8).

As evidenced by the change in EA load between points c and d in FIG. 8, the retractor 10 directly switches from a high EA load to a low EA load without the use of non-mechanical features, such as, for example, pyrotechnics. The change in EA load level thus is mechanical only (i.e., does not rely upon pyrotechnics) and occurs after the spool 12 is rotated to a certain and/or predetermined degree.

Furthermore, by including two symmetrically arranged bands, the EA load is symmetrically distributed in the retractor 10. Having two bands is also beneficial in that the dual bands 70, 72 can provide a greater EA load (BA in FIG. 8) and EA duration in a smaller axial package than what a single band could provide. In other words, for a single band to provide the same EA load and EA duration as the bands 70, 72, the single band would typically have to have a much greater axial width than the bands 70, 72.

The energy absorption characteristics of the retractor 10 can be adjusted and tailored to different vehicle structures and occupant geometries. For example, the EA load of the torsion bar 26 can be adjusted via changes to the torsion bar material and/or to the diametric thickness of the torsion bar. The band material and thickness can also be adjusted to achieve a desired band EA load (BA). Further, the length of the bands 70, 72 can be selected to achieve a desired band EA load (BA) and EA duration (i.e., the time or rotational stroke distance it takes to get from point a to point c in FIG. 8).

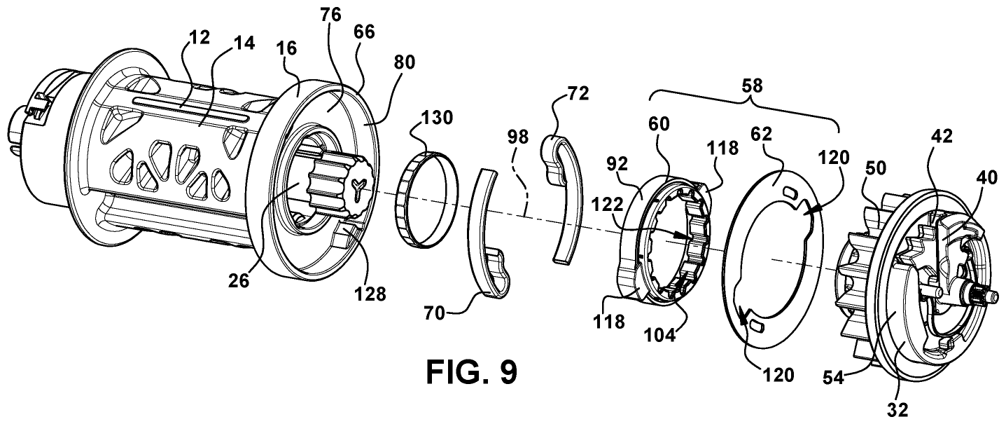

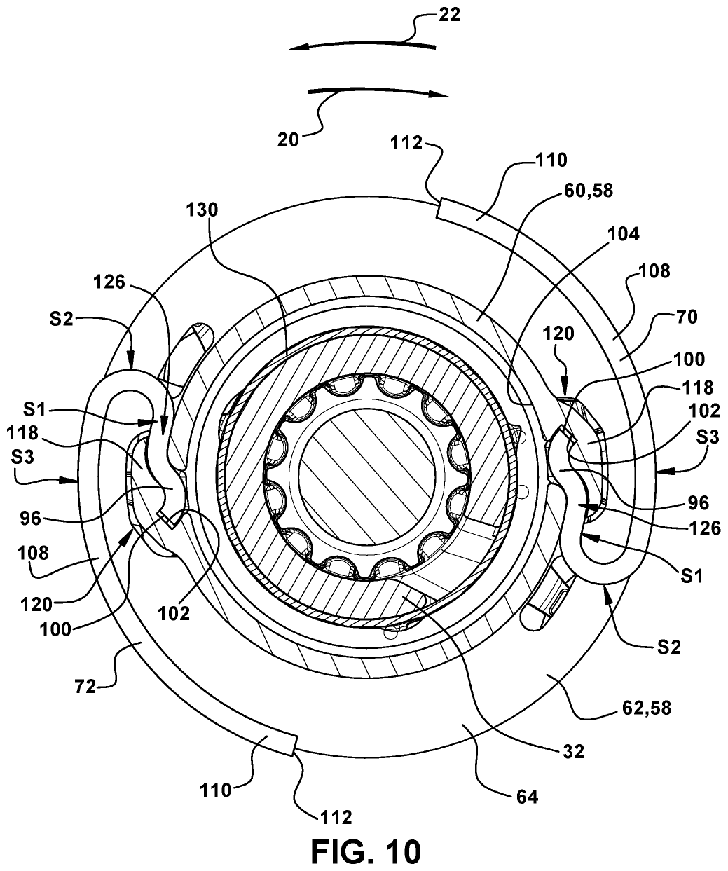

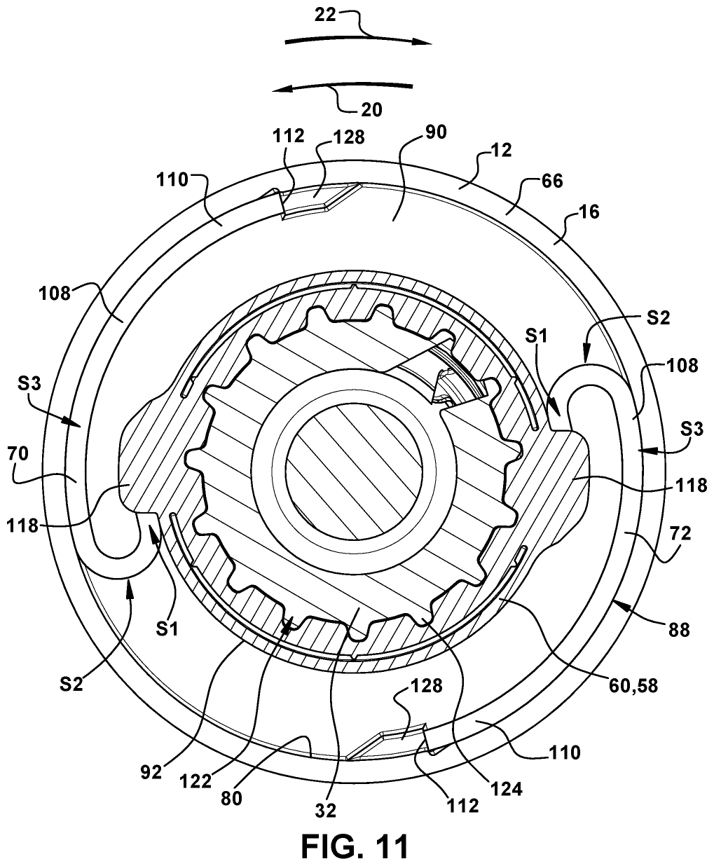

The retractor 10 of FIGS. 1-6 is but one example of a retractor designed in accordance with the teachings of the present disclosure. FIGS. 9-11 depict another. The retractor 10 of FIGS. 9-11 is substantially similar to the retractor 10 of FIGS. 1-6, with some differences being described below. Unlike in FIGS. 1-6, the hub 60 and the flange 62 of the fixing disk 58 of FIGS. 9-11 are separate from one another. Such a two-piece construction of the fixing disk 58 allows for one of the hub 60 and the flange 62 to be application agnostic, while the other can be application specific. The hub 58 includes two projections 118 that are received in corresponding recesses 120 in the flange 62 to rotationally fix the flange to the hub. The inner periphery 102 of the hub 60 also includes recesses 122 in which splines 124 of the locking disk 32 are received to rotationally fix the hub to the locking disk.

The projections 118 of the hub 60 of FIGS. 9-11 include substantially circumferentially extending recesses 126 into which the first end portions 96 of the bands 70, 72 extend. End walls of the recesses 126 define the inner shoulders 102 that the first end faces 100 of the bands 70, 72 abut (i.e., directly contact). The first end portions 96 extend from the inner shoulders 102 through the recesses 126 toward the outer periphery 92 of the hub 60. The first end portions 96 and the recesses 126 may be configured so that a press-fit and/or frictional engagement is created between the first end portions and the recesses. The press-fit and/or frictional engagement between the first end portions 96 and the recesses 126 rotationally fixes the first end portions to the hub 60 and, thus, to the locking disk 32.

Unlike the retractor 10 of FIGS. 1-6, the retractor 10 of FIGS. 9-11 does not include the insert 68. The cavity 88 thus is defined between the spool 12 and the fixing disk 58. More specifically, the cavity 88 is annular and defined by the inner axial surface 76 of the second cylinder portion 16, the axial surface 64 of the flange 62, the outer periphery 92 of the hub 60 and the inner periphery 80 of the second cylinder portion. Furthermore, while the flange 62 may be positioned adjacent to the outer axial surface 66 of the second cylinder portion 16, at least a portion of the flange may be in the second cylinder portion.

The inner periphery 80 of the spool's second cylinder portion 16 includes radially extending projections 128. These projections 128 circumferentially abut and urge the second end faces 112 of the bands 70, 72 to rotate in the same manner as the inner shoulders 114 of the insert 68. By omitting the insert 68, the retractor 10 of FIGS. 9-11 may cut down on manufacturing time and material costs.

Unlike the bands of 70, 72 of FIGS. 1-6, the bands 70, 72 of FIGS. 9-11 include lengths selected such that the bands do not overlap one another along their lengths.

The retractor 10 of FIGS. 9-11 also includes a bearing 130 directly radially between the locking disk 32 and the spool 12. This bearing 130 helps the spool 12 rotate relative to the locking disk 32 and may take up radial tolerances in the retractor 10.

Although the retractor 10 of FIGS. 9-11 is shown as being separate from retractor 10 of FIGS. 1-6, any of the features discussed and/or depicted in relation to one of the retractors can be incorporated into the other, if desired. For example, either of the retractors 10 can be configured to include or to not include an insert 68, a one-piece fixing disk 58, a two-piece fixing disk 58, the hub configuration of FIGS. 1-6, the hub configuration of FIGS. 9-11, the flange configuration of FIGS. 1-6, the flange configuration of FIGS. 9-11, the bearing 130, and so on.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

Having described the invention, the following is claimed:

1. A seatbelt retractor for a vehicle seatbelt webbing, comprising:
a frame;
a spool rotatably mounted to the frame and on which the seatbelt webbing is wound; and
first and second bands disposed in the spool symmetrically about an axis of the spool, the first and second bands being configured to plastically deform to at least partially absorb a load on the seatbelt webbing.

2. The seatbelt retractor of claim 1, further comprising:
a locking disk rotatable relative to the frame, the locking disk being prevented from rotating relative to the frame in an emergency state of a vehicle, first end portions of the first and second bands being connected to the locking disk;
a torsion bar having a first end rotationally fixed to the spool and a second end rotationally fixed to the locking disk, plastic deformation of the torsion bar permitting the spool to rotate about an axis relative to the locking disk in the emergency state, second end portions of the first and second bands being connected to the spool such that rotation of the spool relative to the locking disk plastically deforms the first and second bands.

3. The seatbelt retractor of claim 2, wherein in a normal state of the vehicle, rotation of the spool effects rotation of the locking disk via the torsion bar.

4. The seatbelt retractor of claim 2, wherein the seatbelt retractor has a high energy absorption (“EA”) load level in which the torsion bar and the first and second bands deform plastically to absorb energy in the seat belt webbing, and a low EA load level in which the torsion bar alone deforms plastically to absorb the energy in the seatbelt webbing.

5. The seatbelt retractor of claim 4, wherein after the spool rotates a predetermined degree relative to the locking disk, the second end portions of the first and second bands simultaneously disengage from the spool, such disengagement switching the seatbelt retractor from the high EA load level to the low EA load level.

6. The seatbelt retractor of claim 4, wherein a switch from the high EA load level to the low EA load level does not depend on the use of pyrotechnics.

7. The seatbelt retractor of claim 2, further comprising a fixing disk rotationally fixed to the locking disk and the first end portions of the first and second bands such that the first end portions of the first and second bands are connected to the locking disk via the fixing disk.

8. The seatbelt retractor of claim 7, wherein the fixing disk includes a hub and a flange radially extending from the hub, the first end portions of the first and second bands being fixed to the hub, rotation of the spool relative to the locking disk urging the first and second bands to deform plastically and wind about the hub.

9. The seatbelt retractor of claim 8, wherein the hub and flange are integrally formed in one piece such that the fixing disk is a one-piece construction.

10. The seatbelt retractor of claim 8, wherein the hub and flange are separate from one another such that the fixing disk is a two-piece construction, projections of the hub received in recesses of the flange to rotationally fix the flange to the hub.

11. The seatbelt retractor of claim 8, wherein the first end portions of the first and second bands each extend from an interior of the hub toward an outer periphery of the hub, each of the first and second bands including a middle portion extending between the first and second end portions, each middle portion having a first segment extending from a corresponding first end portion circumferentially around an outer periphery of the hub, a U-turn segment extending from the first segment and a second segment extending from the U-turn segment to a corresponding second end portion.

12. The seatbelt retractor of claim 7, further comprising an insert received in and rotationally fixed to the spool, the second end portions of the first and second bands each abutting an inner shoulder of the insert, rotation of the insert relative to the locking disk urging the second end portions of the first and second bands to rotate relative to the first end portions via the inner shoulders.

13. The seatbelt retractor of claim 12, wherein the fixing disk includes a hub and a flange radially extending from the hub, the first end portions of the first and second bands being fixed to the hub, a cavity in which the first and second bands at least partially extend being defined between the hub, the flange and the insert.

14. The seatbelt retractor of claim 13, wherein at least a portion of the hub extends into the spool such that the first end portions of the first and second bands are connected to the hub in the spool, the flange being external to the spool and having an axial surface adjacent to and/or abutting at least one of an outer axial surface of the insert and an outer axial surface of the spool.

15. The seatbelt retractor of claim 2, further comprising an insert received in and rotationally fixed to the spool, the second end portions of the first and second bands each abutting an inner shoulder of the insert, rotation of the insert relative to the locking disk urging the second end portions of the first and second bands to rotate relative to the first end portions via the inner shoulders.

16. The seatbelt retractor of claim 2, wherein an inner periphery of the spool includes two radially extending projections, the second end portions of the first and second bands abutting the projections, rotation of the spool relative to the locking disk urging the second end portions of the first and second bands to rotate relative to the first end portions via the projections.

17. The seatbelt retractor of claim 16, further comprising a fixing disk rotationally fixed to the locking disk and the first end portions of the first and second bands such that the first end portions of the first and second bands are connected to the locking disk via the fixing disk, the fixing disk including a hub and a flange radially extending from the hub, the first end portions of the first and second bands being fixed to the hub, a cavity in which the first and second bands at least partially extend being defined between the hub, the flange and the spool.

18. The seatbelt retractor of claim 2, further comprising a pretensioner having a turbine wheel rotationally fixed to the locking disk, actuation of the pretensioner rotating the spool in a webbing retraction direction via the turbine wheel, the locking disk and the torsion bar.

19. The seatbelt retractor of claim 1, wherein the seatbelt retractor has a first energy absorption state in which each and every band of the seatbelt retractor is operatively connected to the spool so that rotation of the spool relative to the locking disk plastically deforms all of the bands, and a second energy absorption state in which each and every band of the seatbelt retractor is operatively disconnected from the spool so that none of the bands plastically deform as the spool rotates relative to the locking disk.

20. The seatbelt retractor of claim 1, wherein the spool includes a first cylinder portion on which the seatbelt webbing is wound and a second cylinder portion that has a larger diameter than the first cylinder portion, the first and second bands being in the second cylinder portion.
